(19) United States
(12) Patent Application Publication
(10) Pub. No.: US 2025/0021653 A1
(43) Pub. Date: Jan. 16, 2025

(54) Defenses for Large Language Models

(71) Applicant: Robi Sen, Richland, WA (US)

(72) Inventor: Robi Sen, Richland, WA (US)

(21) Appl. No.: 18/772,237

(22) Filed: Jul. 14, 2024

Related U.S. Application Data
(60) Provisional application No. 63/526,612, filed on Jul. 13, 2023.

(51) Int. Cl. G06F 21/56

(52) U.S. Cl. CPC G06F 21/566; G06F 2221/033

(57) ABSTRACT

An autonomous intelligent agent operates in a distributed computing environment to analyze data collected from a data pool, wherein the data collection is performed in a manner that is independent of activities of a deep-learning neural network (DNN) that fetches data from the data pool. A computer processor circuit implementing the agent comprises at least one generative adversarial neural network (GNN) and at least one Stochastic Neural Network (SNN). The agent retrieves original data from a data pool; uses the SNN to add noise to multiple evaluations of the original data; from the multiple evaluations, determines a proximity of the original data to a decision boundary; based on the proximity, determines if the original data is adversarial; upon determining that the original data is adversarial, employs the GNN to fabricate benign data from the original data; and then replaces the original data in the data pool with the benign data.

### CROSS REFERENCE TO RELATED APPLICATIONS

This application claims the priority benefit of U.S. Provisional Appl. Ser. No. 63/526,612, filed on Jul. 13, 2023; which is hereby incorporated by reference herein in its entirety.

### INTRODUCTION

### I. Field

Deep neural networks (DNNs) include, but are not limited to, image classification, computer vision, text mining, machine translation, malware prevention, and speech processing. Disclosed aspects include, among other things, improving robustness to adversarial examples and other attacks.

### II. Background

The background description includes information that may be useful in understanding the present inventive subject matter. It is not an admission that any of the information provided herein is prior art or relevant to the presently claimed inventive subject matter, or that any publication, specifically or implicitly referenced, is prior art.

Neural networks are comprised of multiple hidden layers, and each of the hidden layers has multiple hidden nodes which consist of an affine map of the outputs from the previous layer and a nonlinear map called an activation function. The nonlinear activation function makes neural networks differ from the linear models, that is, a neural network becomes a linear function if a linear activation function is used. The problem of training a feedforward neural network is to determine a number of adjustable parameters or connection weights based on a set of training data. A trained feedforward neural network can be regarded as a nonlinear mapping from the input space to the output space.

Generative Neural Networks (GNNs), particularly Large Language Models (LLMs), such as Chat GPT 4, are susceptible to a plethora of adversarial attacks. The architecture of generative networks makes them challenging to defend, with the level of difficulty often contingent on the specific characteristics of the attack and the model.

Studies have unveiled the vulnerability of a well-trained DNNs by demonstrating the ability of generating barely noticeable (to both human and machines) adversarial images that lead to misclassification. For example, a slightly modified image can be easily generated and fool a well-trained DNN image classifier with high confidence. More broadly, machine learning (ML) models, are vulnerable to adversarial examples: malicious inputs modified to yield erroneous model outputs, while appearing unmodified to human observers.

It is possible for an attacker to control a remotely hosted DNN with no knowledge of either the model internals or its training data. The only capability of a black-box adversary is to observe labels given by the DNN to chosen inputs. This is relevant to scenarios in which users interact with classifiers hosted remotely by a third party that keeps the model internals secret.

For example, the inputs (i.e., a synthetic dataset) might be generated by the adversary, while the outputs are labels assigned by the target DNN and observed by the adversary. Adversarial examples are crafted using the substitute parameters that are found to be misclassified by the target DNN.

A classifier is an ML model that learns a mapping between inputs and a set of classes. For instance, a malware detector is a classifier taking executables as inputs and assigning them to the benign or malware class. Classifiers are vulnerable to integrity attacks. Such attacks are often instantiated by adversarial examples: legitimate inputs altered by adding small, often imperceptible, perturbations to force a learned classifier to misclassify the resulting adversarial inputs, while remaining correctly classified by a human observer. An untargeted attack refers to crafting an adversarial example leading to misclassification; whereas a targeted attack refers to modifying the example in order to be classified as a desired class.

Zeroth order optimization (ZOO) attacks estimate the gradients of the targeted DNN for generating adversarial examples. Zeroth order stochastic coordinate descent along with dimension reduction, hierarchical attack and importance sampling techniques can efficiently attack black-box models. By exploiting zeroth order optimization, improved attacks to the targeted DNN can be accomplished, sparing the need for training substitute models and avoiding the loss in attack transferability.

Fast gradient sign method (FGSM) uses the sign of the gradient from the back propagation on a targeted DNN to generate admissible adversarial examples. FGSM can be viewed as an attack framework based on first-order projected gradient descent.

Jacobian-based Saliency Map Attack (JSMA) is a greedy attack algorithm that iteratively modifies the most significant pixel based on the saliency map, which characterizes the input-output relation of a targeted DNN, for crafting adversarial examples. In each iteration, JSMA recomputes the saliency map and uses the derivative of the DNN with respect to the input image as an indicator of modification for adversarial attacks. JSMA has been applied to other machine learning tasks and DNN architectures.

DeepFool is an untargeted attack algorithm that aims to find the least distortion (measured by Euclidean distance) that leads to misclassification by projecting an image to the closest separating hyperplane that indicates the decision boundaries of each class.

The Carlini & Wagner (C&W) Attack is an optimization problem that exploits the internal configurations of a targeted DNN for attack guidance, and uses the L2 norm (i.e., Euclidean distance) to quantify the difference between the adversarial and the original examples.

Two types of defense strategies are: (1) reactive where one seeks to detect adversarial examples, and (2) proactive where one makes the model itself more robust. The defender may increase the attacker's cost by training models with higher input dimensionality or modeling complexity, as these two factors increase the number of queries required to train substitute models. Some defense mechanisms fall into a category known as gradient masking. These techniques construct a model that does not have useful gradients, e.g., by using a nearest neighbor classifier instead of a DNN. Such methods make it difficult to construct an adversarial example due to the absence of a gradient, but are often still vulnerable to the adversarial examples that affect a smooth version of the same model. It has been shown that nearest neighbor was vulnerable to attacks based on transferring adversarial examples from smoothed nearest neighbors. Furthermore, a black-box attack based on transfer from a substitute model overcomes gradient masking defenses.

The functionalities of recent LLMs can be flexibly modulated via natural language prompts. This renders them susceptible to targeted adversarial prompting, e.g., Prompt Injection (PI) attacks enable attackers to override original instructions and employed controls. Generally, the user is directly prompting the LLM. However, using Indirect Prompt Injection, adversaries can remotely (without a direct interface) exploit LLM-integrated applications by strategically injecting prompts into data likely to be retrieved. Adversaries can now remotely affect other users' systems by strategically injecting the prompts into data likely to be retrieved at inference time. If retrieved and ingested, these prompts can indirectly control the model.

Passive PI methods rely on retrieval to deliver injections. For example, for search engines, the prompts could be placed within public sources (e.g., a website or social media posts) that would get retrieved by a search query. For code auto-completion models, the prompts could be placed within imported code available via code repositories. Even with offline models that retrieve personal or documentation files (e.g., the ChatGPT Retrieval Plugin), the prompts could be injected by poisoning the input data. In active PI, the prompts are actively delivered to the LLM, e.g., by sending emails containing prompts that can be processed by automated spam detection, personal assistant models, or LLM-augmented email clients.

To make the injections more stealthy, attackers use multiple exploit stages, where an initial smaller injection instructs the model to fetch a larger payload from another source. Additionally, improvements in models' capabilities and supported modalities could open new doors for injections. For example, with multi-modal models (e.g., GPT-4), the prompts could be hidden in images. To circumvent filtering, prompts can also be encoded. Moreover, instead of feeding prompts to the model directly, they could be the result of Python programs that the model is instructed to run, thus enabling encrypted payloads to pass safeguards.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

The aspects disclosed herein can be adapted to methods, individual processors, systems of processing elements, computer software residing on non-transitory computer-readable memory that is programmed to perform disclosed methods, and/or electronic circuitry, for example. Disclosed aspects can be generalized to ML models that are not DNNs, such as logistic regression (LR), support vector machines (SVM), decision trees (DT), and nearest neighbor (kNN). Other ML models might be employed.

In one aspect, an image classifier trained by a convolutional neural network (CNN) takes an image as an input and produces a confidence score for each class as an output. Due to application popularity and security implications, image classification based on CNNs is currently a major focus and a critical use case for studying the robustness of DNNs.

In supervised learning, we may be interested in developing a model to predict a class label given an example of input variables. This predictive modeling task is called classification. Classification can also be referred to as discriminative modeling. Here, we use the training data to find a discriminant function f(x) that maps each x directly onto a class label, thereby combining the inference and decision stages into a single learning problem. Specifically, one wishes to go from an observation x to a label y (or probability distribution on labels).

In one aspect, an autonomous agent is configured to provide security-as-a-service (SaaS) to a DNN configured to access a data pool. The agent comprises at least a first interface configured to interact with the data pool; at least a second interface configured to interact with the DNN; and circuitry configured to be responsive to the DNN's request for SaaS, and to operate the agent as middleware between the DNN and the data pool for filtering and/or cleaning adversarial examples received from the data pool to provision benign examples that are communicated to the DNN. In some instances, the agent may comprise at least a third interface configured for monitoring behavior of other agents and/or communicating with other agents.

In another aspect, an autonomous agent is configured to operate in a distributed environment independent of the DNN. The agent comprises at least a first interface configured to retrieve data from a data pool in a manner that operates independently of the DNN; and circuitry configured for at least one of quarantining, cleaning, and/or removing adversarial examples in the data pool. The at least one of quarantining, cleaning, and/or removing adversarial examples may be effected via operating the first interface. In some instances, the agent might comprise a second interface for communicating with the DNN. In some instances, the agent may comprise at least a third interface configured for monitoring behavior of other agents and/or communicating with other agents. Autonomous agents, as used herein, can comprise software agents, intelligent agents, and/or any other type of agent described herein, and can be configured to operate in accordance with roles and capabilities of the agents described herein.

In a distributed system where autonomous agents work together towards a common objective, monitoring each other's behavior and establishing trustworthiness is crucial for improving Byzantine fault tolerance. By assessing the trustworthiness of individual agents and leveraging consensus mechanisms to calculate a global trustworthiness score, the system can enhance its resilience against malicious or faulty behavior. Disclosed methods of trustworthiness scoring achieve fault tolerance by leveraging the consensus of honest agents, discounting the influence of malicious agents, and utilizing the trustworthiness scores to tune decision-making. By mitigating malicious or faulty behavior, this tuning improves the operation of computer processors on which the autonomous agents reside, and how computers could carry out one of their basic functions of storage and retrieval of data. Even when a majority of agents are malicious, the honest agents can collaborate, reach a consensus, and make informed decisions based on the trustworthiness scores, thereby improving fault tolerance in the system.

The focus of some disclosed aspects is on specific improvements in computer capabilities, particularly improvements to computer functionality itself. Disclosed methods, non-transitory computer-readable memory with instructions to configure a processor to function in a prescribed manner, and processor-plus-memory configurations provide for improving the operation of the computer processor itself. Furthermore, some disclosed aspects might comprise non-conventional and non-generic arrangements of known, conventional parts.

In one aspect, a method for operating a software agent comprises collecting information from the environment; storing the information in a knowledge base; employing reasoning mechanisms to process the information and make decisions; executing actions in the environment based on the decisions; communicating with other agents or external entities to exchange information, coordinate activities, collaborate, or negotiate; monitoring the software agent's own and/or other agents' actions; setting goals and planning actions to achieve the goals; and learning and adapting by updating the knowledge base.

Collecting information can comprise employing sensors such that the information comprises measurements of physical phenomena. Such physical measurements might include measurements of a device's operation, such as the amount of time it takes a computer processor to complete a particular task, the amount of storage capacity in a physical storage medium, or the amount of electromagnetic signals flowing through a physical-layer communication medium.

Executing actions in the environment can comprise causing a measurable change in a physical environment, such as causing a change in how a physical device operates. As such, the change in operation of a physical device, such as improving its efficiency, is a measurably quantifiable property. For example, the efficiency of how a computer processor performs its operations directly affects how much power the processor uses, and/or might directly result in the amount of hardware required to perform a given task within a given time constraint.

When multiple devices coordinate activities, collaborate, or negotiate, it constitutes tuning the system of devices to improve the system's operation. As such, the improved operation of the system can be quantified as a measurement in the time it takes to perform a given task, the amount of energy consumed to perform the task, the amount of hardware required to perform the task, and/or the amount of physical-layer resources needed to communicate coordinate, collaborate, or negotiate.

Learning and adapting both constitute tuning a physical device or system to improve its function. Tuning the device or system improves efficiency of its operation, such as requiring fewer computations, fewer processing cycles, fewer function calls, fewer memory accesses, etc. The effects of tuning can be quantified using measurable operating parameters of a computer system, such as the speed that a computer system performs a particular operation. Since the knowledge base is used to execute actions, updating the knowledge base in a manner that affects the execution of actions constitutes tuning. Furthermore, updating data structures disclosed herein can improve the way a computer processor stores and retrieves data in memory, communicates with other processors, routes data through a network, and/or improves the function of processing devices by preventing or reducing operations that detract from their performance. Providing security to a computer improves its function, as quantified by any physical measurements that indicate the performance, efficiency, and/or capacity of its intended operation, as unintended access to computing resources necessarily reduces the utility of the computer.

Tuning a machine, such as a physical computer processor or a virtual computer (which is comprised of physical devices, so tuning a virtual computer results in tuning physical devices), to better protect a device or system from malware, unauthorized access, or undesirable operations directly impacts a computer's operation, its operation being quantifiable via physical measurements of the machine.

In another aspect, a method performed by an autonomous agent in a distributed environment comprises monitoring behavior of a plurality of autonomous agents in the distributed environment; assigning a trustworthiness score to each autonomous agent based on the monitored behavior; exchanging trustworthiness scores among the plurality of autonomous agents; collaborating with the plurality of autonomous agents to determine a global trustworthiness score for each autonomous agent through a consensus mechanism; updating the trustworthiness scores based on ongoing monitoring of behavior and consensus results; and utilizing the trustworthiness scores to inform decision-making processes within the distributed environment. As used herein, a distributed environment can mean a distributed computing environment or a decentralized computer network.

The trustworthiness scores are used to tune the decision-making processes, thereby tuning the agent to more effectively execute actions that protect a computing device from malicious instructions. For example, the actions might include quarantining, cleaning, or deleting the malicious instructions, thereby improving security of the computing device. This is a specific improvement in how computers carry out their basic functions of storage and retrieval of data. Moreover, the mitigation of malicious instructions improves the computer's utility by preventing the computer from being misused for unauthorized activities.

In another aspect of the disclosure, a method utilized by a software agent in a distributed environment comprises utilizing access methods to crawl a plurality of local and/or remote databases to retrieve data; employing searching or language-processing machinery to detect a signature; producing an event based on the signature; passing the event to reasoning or inferencing machinery to determine a response to the event; combining the content of the events with rule-based or knowledge content; deciding on an action to be taken based on the event; verifying the decision and/or action using a security function; receiving authorization from an authorizing entity to execute the action; and employing learning machinery, if instructed by the authorizing entity, to increase its weighting for at least one event type corresponding to the event.

employing learning machinery to increase weighting for the at least one event type constitutes tuning the agent to better respond to a signature that indicates malicious instructions, and thereby improves the agent's response to malicious instructions in order to improve the performance of computers that would otherwise run the malicious instructions. This can enable the agent to execute actions that are more effective against security threats that compromise a computer's function. Such aspects improve the functioning of a computer processor and how the computer reads data from memory and uses the data in its operations.

In one aspect, a computer processor circuit implementing an agent comprises at least one generative adversarial neural network (GNN) and/or at least one Stochastic Neural Network (SNN). The computer processor can comprise software and/or circuitry for: retrieving original data from a data pool; employing the SNN for adding noise to multiple evaluations of the original data; from the multiple evaluations, determining a proximity of the original data to a decision boundary; based on the proximity, and determining if the original data is adversarial. In a further aspect, the computer processor can comprise software and/or circuitry for: upon determining that the original data is adversarial, employing the GNN to fabricate benign data from the original data; and replacing the original data in the data pool with the benign data.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIGS. 1A and 1B illustrate intelligent agent systems according to disclosed aspects.

FIG. 2A-2F illustrate various functional aspects of disclosed software agents.

FIG. 3A illustrates components of a software agent according to disclosed aspects.

FIG. 3B depicts a method of operating a software agent in some disclosed aspects.

FIG. 4A illustrates components of a software agent according to disclosed aspects.

FIG. 4B illustrates a method performed by one or more software agents in accordance with some disclosed aspects.

FIG. 4C depicts functional aspects of a software agent according to disclosed aspects.

FIG. 5 depicts a processor with memory, such as a GPU parallel computing architecture, that can be configured to perform any of the methods disclosed herein.

### DETAILED DESCRIPTION

The description that follows includes exemplary systems, methods, techniques, instruction sequences, and computer program products that embody techniques of this disclosure. However, it is understood that the described aspects may be practiced without these specific details. Apparatuses and methods are described in the following description and illustrated in the accompanying drawings by various blocks, modules, components, circuits, steps, processes, algorithms, etc. (collectively referred to as “elements”). These elements may be implemented using electronic hardware, computer software, firmware, or any combination thereof.

Aspects disclosed herein can be configured to operate with various types of artificial neural networks, including (but not limited to) feed forward, multilayer perceptron, deep feed forward, radial basis, convolutional neural networks, recurrent, gated recurrent, long/short term memory, auto encoder, variational auto encoder, denoising auto encoder, sparse, nested, Markov chain, Hopfield, Boltzman machine, restricted Boltzman machine, deep belief, deep convolutional, deep convolutional inverse graphics, deconvolutional, generative adversarial, liquid state machine, extreme learning machine, echo state, deep residual, Kohoren, support vector machine, Neural Turing Machine, sequence-to-sequence, modular neural networks, and combinations thereof.

A deep neural network (DNN) is an ML technique that uses a hierarchical composition of n parametric functions to model an input x. Each function fᵢ. for i∈1 . . . n, is modeled using a layer of neurons, which are elementary computing units applying an activation function to the previous layer's weighted representation of the input to generate a new representation. The DNN comprises an input layer, a number of hidden layers, and an output layer. Each layer is parameterized by a weight vector θᵢ impacting each neuron's activation. Such weights hold the knowledge of a DNN model F and are evaluated during its training phase. Thus, a DNN defines and computes:

$$F ( x ) = {f}_{n} ( {θ}_{n} , {f}_{n - 1} ( {θ}_{n} , … , {f}_{2} ( {θ}_{2} , {f}_{1} ( {θ}_{1} , x ) ) ) )$$

The training phase of a DNN F learns values for its parameters θ_{F}={θ₁, . . . , θₙ}. In classification, the goal is to assign inputs a label among a predefined set of labels. The DNN is given a large set of known input-output pairs (˜x, ˜y) and it adjusts weight parameters to reduce a cost quantifying the prediction error between the prediction F(˜x) and the correct output ˜y. The adjustment is typically performed using techniques derived from the backpropagation algorithm. Briefly, such techniques successively propagate error gradients with respect to network parameters from the network's output layer to its input layer.

During the test phase, the DNN is deployed with a fixed set of parameters OF to make predictions on inputs unseen during training. We consider classifiers: the DNN produces a probability vector F(˜x) encoding its belief of input ˜x being in each of the classes. The weight parameters OF hold the model knowledge acquired by training. Ideally, the model should generalize and make accurate predictions for inputs outside of the domain explored during training. However, attacks manipulating DNN inputs with adversarial examples show that this is not the case in practice.

In a black box attack, adversaries need not know internal details of a system to compromise it. The adversary has no knowledge of the architectural choices made to design the DNN, which include the number, type, and size of layers, nor of the training data used to learn the DNN's parameters. The adversarial goal is to produce a minimally altered version of any input ˜x, named adversarial sample, and denoted ˜x*, misclassified by oracle O: O(˜x*)≠O(˜x). In some instances, misclassification is achieved by adding a minimal perturbation δx so as to evade detection. The best metric for evaluating the similarity between a benign example and a corresponding adversarial example is still an open question and may vary in different contexts.

Some aspects can employ Generative Adversarial Networks (GANs) or Generative Neural Networks (GNNs) in agents that constantly crawl data pools looking for poisoned information. Generative modeling is an unsupervised learning task in machine learning that involves automatically discovering and learning the regularities or patterns in input data in such a way that the model can be used to generate or output new examples that plausibly could have been drawn from the original dataset.

In the GAN framework, two models are trained simultaneously in an adversarial setting: a generative model G that emulates the data distribution, and a discriminative model D that predicts whether a certain input came from real data or was artificially created. GANs are based on a game theoretic scenario in which the generator network must compete against an adversary. The generator network directly produces samples. Its adversary, the discriminator network, attempts to distinguish between samples drawn from the training data and samples drawn from the generator.

GANs can be used to diminish the effect of adversarial perturbations in data, by “projecting” input images onto the range of the GAN's generator prior to feeding them to the classifier. In some aspects, an agent GAN might locate and preprocess adversarial examples on behalf of one or more DNNs separate and unrelated to current operations of the one or more DNNs. For example, the separate and unrelated to current operations can mean that the agent GAN might crawl data that a DNN might ingest at some future time for some operation that is not directly related to its current operation.

In one aspect, an input data x might be projected onto the range of G by minimizing ∥G(z)−x∥² for a predetermined number of steps of GD, and using several random initializations of z. The resulting reconstruction G(z) reduces any adversarial noise. G(z) is then substituted for x before it can be passed to a classifier. In this example, retraining the classifier might be avoided.

In one example, let X be the visual space and Z be the latent space. The mapping F: X→Z performs image abstraction, which encodes the image x∈X into a code z E Z. The mapping Z→X performs image generation, which generates image x∈X from the output of encoder z∈Z. The loss function is ∥G(F(x))−x∥².

The disclosed techniques can be adapting to various data types (e.g., speech, time series, graphs, images, spreadsheets, program code, text, etc.) and different machine learning models and neural network architectures (e.g., recurrent neural networks). In addition, disclosed aspects might incorporate side information of a dataset (e.g., expert knowledge) and existing adversarial examples (e.g., security leaks and exploits).

A software agent is a computer program that acts for a user or other program in a relationship of agency. The agent has the authority to decide which, if any, action is appropriate. Software agents may be autonomous or work together with other agents. The concept of an agent provides a convenient and powerful way to describe a complex software entity that is capable of acting with a certain degree of autonomy in order to accomplish tasks on behalf of its host. But unlike objects, which are defined in terms of methods and attributes, an agent is defined in terms of its behavior. For example, an agent has:
persistence (code is not executed on demand but runs continuously and decides for itself when it should perform some activity)
autonomy (agents have capabilities of task selection, prioritization, goal-directed behavior, decision-making without human intervention)
social ability (agents are able to engage other components through some sort of communication and coordination, they may collaborate on a task)
reactivity (agents perceive the context in which they operate and react to it appropriately).

A software agent can be an intelligent agent (IA), an autonomous agent (capable of modifying the methods of achieving their objectives), a distributed agent (being executed on physically distinct computers), a part of a multi-agent system (i.e., distributed agents that work together to achieve an objective that could not be accomplished by a single agent acting alone), and/or a mobile agent (that can relocate their execution onto different processors).

An IA is an agent acting in an intelligent manner; It perceives its environment, takes actions autonomously in order to achieve goals, and may improve its performance with learning or acquiring knowledge. An agent has an “objective function” that encapsulates all the IA's goals. Such an agent is designed to create and execute whatever plan will, upon completion, maximize the expected value of the objective function. An agent that is assigned an explicit “goal function” is considered more intelligent if it consistently takes actions that successfully maximize its programmed goal function. The “goal function” encapsulates all of the goals the agent is driven to act on; in the case of rational agents, the function also encapsulates the acceptable trade-offs between accomplishing conflicting goals. Goals can be explicitly defined or induced. If the AI is programmed for “reinforcement learning”, it has a “reward function” that encourages some types of behavior and punishes others. Alternatively, an evolutionary system can induce goals by using a “fitness function” to mutate and preferentially replicate high-scoring AI systems.

Learning has the advantage that it allows agents to initially operate in unknown environments and to become more competent than its initial knowledge alone might allow. The most important distinction is between the “learning element”, which is responsible for making improvements, and the “performance element”, which is responsible for selecting external actions. The learning element uses feedback from the “critic” on how the agent is doing and determines how the performance element, or “actor”, should be modified to do better in the future. The performance element is what we have previously considered to be the entire agent: it takes in percepts and decides on actions. The last component of the learning agent is the “problem generator”. It is responsible for suggesting actions that will lead to new and informative experiences.

The basic attributes of an autonomous software agent are that agents:
are not strictly invoked for a task, but activate themselves,
may reside in wait status on a host, perceiving context,
may get to run status on a host upon starting conditions,
do not require interaction of a user,
may invoke other tasks, including communication.

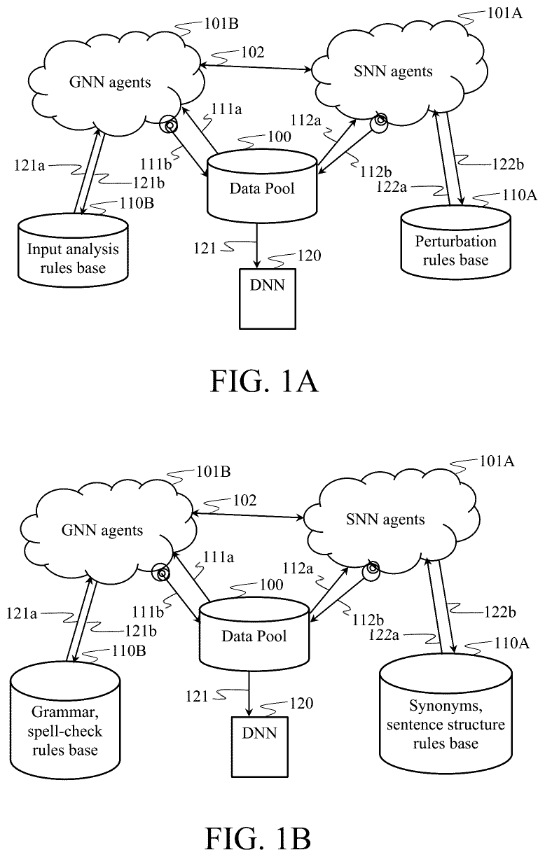

In FIG. 1A, an ML model, such as a DNN 120, which may be a stochastic or deterministic network, accesses 121 at least one data pool 100 that can possibly contain poisoned data. While deterministic neural networks always produce the same output for a given input, stochastic neural network outputs can vary, especially when the inputs are near decision boundaries. In some disclosed examples, A Stochastic Neural Network (SNN) agent 101A operating autonomously (relative to the DNN 120) identifies data in a data pool 100 that might be poisoned by adding noise to multiple evaluations of the data and/or employing stochastic outputs, and then determining corresponding variances and/or variability in the neural network outputs. From the multiple evaluations, the data's proximity to a decision boundary can be determined. The proximity can be compared to one or more threshold values. Each threshold value might correspond to at least one prescribed action to be taken. Upon the proximity being less than a threshold value, SNN agents 101A might perform the at least one prescribed action. SNN agents 101A might direct the DNN 120 to improve its learning in order to move the specified inputs away from a decision boundary. In some instances, the SNN agent or agents 101A might remove, quarantine, or replace 112b suspect data in the data pool 100.

A generative (adversarial) neural network (e.g., GNN, or GAN) agent 101B is a deep learning architecture that trains two neural networks to compete against each other to generate more authentic new data from a given training dataset. The GNN agent 101B comprises a generator network that creates fabricated data and a discriminator network that attempts to distinguish the fabricated data from the real data.

For example, a GNN agent 101B can fabricate data from an existing set of data in the data pool 100. A GNN is “adversarial” because it trains the two different networks and pits them against each other. The generator network generates fabricates new data by taking an input data sample and modifying it as much as possible. The discriminator network is a classifier that tries to predict whether its data input belongs in the original dataset. In other words, the discriminator network determines whether the generator's output data is fabricated or original. The system generates newer, improved versions of fabricated data until the discriminator network can no longer distinguish fabricated from original data. A GNN agent 101B then replaces the original data in the data pool 100 with the fabricated data, thereby cleansing data in the data pool 100 of any poisoning.

GNNs create or generate new examples in the input distribution, such as by employing randomizers (z) and/or interpolation. In some examples, GNN agents 101B, operating autonomously from the DNN 120, are configured to mitigate the effects of poisoning by randomizing, fuzzing, and/or generalizing the data in the data pool 100.

Adversarial attacks typically rely on precise manipulations of the input data 100 to mislead the network 120. Thus, poisoned data is likely to be near a decision boundary. SNN agents 101A can employ a perturbation rule base 110A to operate on data retrieved 112a from the data pool 100 or operate on data retrieved 121 by the DNN 120 before it is operated upon by the DNN, and identify data that is near a decision boundary, and thus, likely to be poisoned. SNN agents 101A might take any of various actions, such as removing, cleaning, fuzzing, and/or quarantining poisoned data; and/or informing the DNN 120 of poisoned data.

In some instances, the SNN agents 101A might provision a neural network classifier that filters data near decision boundaries (i.e., likely poisoned data) from clean data. Such a classifier might be implemented by way of an autoencoder which compares inputs to outputs and determines the variance and/or variation therefrom. A predetermined number of runs with different randomizations might be implemented, and the computed variance and/or variation might be compared to a threshold for determining the likelihood of poisoned data.

Some aspects can employ GANs and/or GNNs in agents 101B configured to crawl 111a data pools 100 and seek poisoned information. In some instances, GNN agents 101B might collaborate with SNNs 101A. In some aspects, GNN agents 101B and SNN agents 101A can be one in the same. For example, GNN agents 101B might employ and/or comprise SNNs 101A. GNN agents 101B might perform data analysis on the retrieved 121a data, such as to detect anomalies in the input data. GNN agents 101B might perform a fuzzing operation that modifies (e.g., alters, adds noise to, and/or generalizes) the data and then returns 111b modified data to the data pool 100 (e.g., replaces the original data with the modified data). This can make it more challenging for an attacker to directly manipulate the model 120. The agents 101B may employ input-data analysis and/or fuzzing parameters obtained 121a from an input analysis rule base 110A. GNNs 101B might operate in coordination with SNNs 101A, and might exchange data and/or control information therebetween.

The SNNs 101A can provide for, and exploit randomness, in the decision-making process of a neural network. In some instances, the randomness can be designed to enhance the robustness of the network against adversarial attacks. An SNN 101A can incorporate randomness or probabilistic elements into its architecture or training process.

This randomness can manifest in various ways, such as using stochastic activation functions, introducing noise during training, and/or incorporating dropout layers. Stochastic activation functions, such as stochastic ReLU or stochastic binary neurons, can be used. These functions introduce randomness in the output of the neurons, which is normally used to help in introducing variability and preventing overfitting. An SNN 101A normally includes noise during the training process. This noise can help the model to generalize better by preventing it from fitting the training data too closely. Dropout is commonly used in SNNs. During training, dropout randomly sets a fraction of the neurons in a layer to zero. This helps in preventing overfitting and encourages the network to learn more robust features. In some cases, stochastic neural networks can produce probabilistic outputs instead of deterministic ones. This can be useful in tasks where uncertainty estimation is important, such as in Bayesian neural networks. Here, SNN agents 101A might include noise in the analysis of the data pool 100 to identify data that is near decision boundaries.

In some instances, SNN agents 101A may employ a perturbation rules base 110A, which might comprise local storage and/or shared storage of perturbations that define the extent, variance, or range of randomness the SNN agents 101A employ. The perturbations might indicate random distributions, such as might be defined by mean and variance, that might be applied to input data from the data pool 100, and/or that might be applied to the latent space, such as when an SNN agent 101A has an autoencoder configuration. The perturbation rules base 110A might comprise the fraction of neurons in at least one layer to zero. The perturbation rules base 110A might comprise characterizations of the randomness used in stochastic activation functions.

In some instances, the SNN agents 101A can retrieve 112a data from the data pool 100, configure the retrieved data and/or each SNN agent's operating parameters (e.g., latent space, drop out, activation functions) with a set of perturbations (e.g., randomness) from the characterizations retrieved 122a from the perturbation rules base 110A, operate on the retrieved data, and determine a variance and/or variability in each SNN agent's set of neural network outputs and/or latent space resulting from the same input data, but with randomness applied according to the set of perturbation parameters. The variance and/or variability in neural network outputs and/or latent space, which might be compared to at least one threshold number, can be used in a determination process to determine whether the retrieved 112a data is near a decision boundary, and thus, is likely to be poisoned. The SNN agent(s) 101A, upon determining the likelihood of poisoned data, can be configured to take at least one prescribed action.

In some instances, probabilistic outputs might be used to identify whether an input data resides near a decision boundary, which can be useful in determining whether the input data is likely to be poisoned. In some instances, stochastic activation functions, introducing noise into the input data, and/or incorporating dropout layers might be used to identify whether an input data resides near a decision boundary. In some instances, upon determining that retrieved data is likely to be poisoned, a decision process may be employed by the SNN agent(s) 101A to operate 112b on the data in the data pool 100 and/or update network parameters of the DNN 120.

In some instances, agents (e.g., in 101A and/or 101B) might monitor 102 each other's behavior and develop consensus-based trustworthiness scores for each other. The agent might communicate the scores with other agents. One or more agents might develop a consensus trustworthiness score based on scores received from other agents. An agent's trustworthiness score might be used to weight its input to a consensus decision-making process. In some instances, a trustworthiness score connotes an agent's permissions and responsibilities, such as in communicating 102 with other agents, interacting with the data pool 100, updating (121b and/or 122b) the rules base (110A and/or 110B) and/or communicating with the DNN 120. It should be appreciated that agents and/or groups of agents (110A and/or 110B) might communicate 102 with each other to exchange information, coordinate activities, collaborate, participate in consensus operations, and/or negotiate. Communication 102 can involve employing reasoning mechanisms to process the information and make decisions; and executing actions in the environment based on the decisions. Communication 102 can comprise a process of collectively setting goals and planning actions to achieve the goals. Communication 102 can further involve the agents (110A and/or 110B) learning and adapting by updating (121b and/or 122b) the knowledge base (110B and/or 110A).

FIG. 1B illustrates an exemplary implementation wherein the DNN 120 employs a large language model (LLM). Agents 101A and 101B might be provisioned to continuously crawl one or more data pools 100. In one example, GNN agents 101B might employ Grammatical Neural Networks, which are a type of neural network that can understand and generate human language. They can be used to detect anomalies in the input data, such as unusual or suspicious phrases that might indicate an adversarial attack. For example, an attacker might try to manipulate a language model by using a carefully crafted prompt. A GNN agent 101B might detect this manipulation by recognizing that the prompt does not follow the usual patterns of human language. Various analytical approaches might involve spell checking, grammar checking, punctuation checking, detection of anomalous characters, and/or detection of particular patterns of characters, including code snippets. With respect to grammar checking, GNN agents 101B might evaluate text or voice data with respect to rules, such as phonology, morphology, syntax, phonetics, semantics, and pragmatics.

In one instance, the GNN agents 101B retrieve 111a data, and detect anomalous data by performing the above rules analyses. In some instances, the GNN agents 101B clean the data and return 111b the cleaned data to data pool 100 while providing for deleting or quarantining the poisoned data from the data pool 100. Since adversarial attacks typically rely on precise manipulations of the input data to mislead the network, GNN/SNN agents 101B/101A might infer meaning from the data, followed by reformatting the data into a form that retains the same or similar meaning. For example, the GNN/SNN agents 101B/101A might employ alternative sentence structure, alternative word sequencing, alternative phraseology, alternative style, synonyms, alternative punctuation, and the like.

In some aspects, agents 101B/101A might translate the data from a first language to a second language. The agents 101B/101A might optionally translate the data in the second language back to the first language. Such translations can filter out anomalies in the data which attackers use to manipulate the DNN 120.

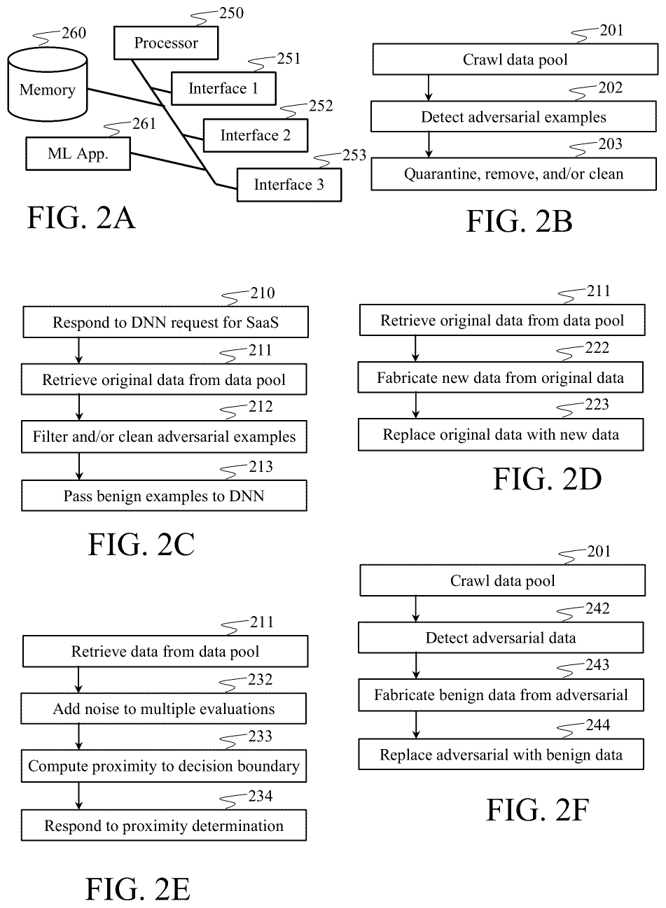

FIG. 2A illustrates a processing environment implementing a GNN agent and/or SNN agent. The processing environment can include a processor 250, a memory 260, at least one Machine Learning application (ML) 261, and one or more communication interfaces (e.g., 251-253). In one aspect, an interface layer (251-253) forwards data to the ML 261, which can include a training and inference manager. The training and inference manager can be a system or service including hardware and software, which can receive a request to train a neural network, and can provide data for a request to a training module. The training module can select an appropriate model or neural network to be used, and can train a model using relevant training data. Training data might be stored in a training data repository, received from the data pool, or obtained from a third party provider. Once a neural network is trained and evaluated, a trained neural network can be stored in a model repository. There may be multiple models in the processing environment, as may be utilized based on a number of different factors. It should be appreciated that randomness introduced by the SNN can disrupt adversarial attacks, while the GNN can detect anomalies in the input data. This can make it more challenging for an attacker to successfully manipulate the model.

In one aspect, a request for SaaS may be received from a DNN for data that is at least partially determined or impacted by a trained neural network (e.g., ML 261). This request can include input data to be processed using a neural network for detecting adversarial examples (e.g., to obtain one or more inferences or other output values, classifications, or predictions) and/or generating benign examples therefrom. Alternatively, the processing environment is instantiated independently of the DNN. In one example, an inference module can obtain an appropriate trained network from a model repository, if not already stored locally 260. The inference module can provision data from the data pool as input to a first trained network, which can then generate one or more inferences as output. This may include, for example, a classification of an instance of input data. In one aspect, inferences can then be transmitted to a second trained network, such as to generate benign examples. In one aspect, context data for a particular DNN or data pool may also be stored to a context data repository, which may include data about a DNN, data pool, and/or known attack signatures, which may be useful as input to a network in generating inferences, or determining data to return to a data pool or DNN after obtaining instances. Relevant data, which may include at least some of input or inference data, may be stored in the local database 260 for processing future requests. This data may also be collected and used to further train models, such as to provide more accurate inferences for future requests.

The focus of some disclosed aspects is on specific improvements in computer capabilities, particularly improvements to computer functionality itself. By removing poisoned data from the data pool, the GNN agent effectively tunes the DNN, enabling the DNN to operate more efficiently by producing a higher proportion of correct outputs. This reduces the number of processing operations (and thus, number of computer cycles), the amount of computing time, and the processor's power usage for the DNN to arrive at the correct output. If the data pool is used to train the DNN, by removing, quarantining, or replacing poisoned data, the GNN agent tunes the DNN to learn faster, thereby enabling the DNN to operate more efficiently by reducing the number of processing operations (and thus, number of computer cycles and processing hardware), the compute time, memory access overhead, memory overhead, and power usage.

Disclosed methods, non-transitory computer-readable memory with instructions to configure a processor to function in a prescribed manner, and processor-plus-memory configurations provide for improving the operation of the computer processor(s) itself. Furthermore, some disclosed aspects might comprise non-conventional and non-generic arrangements of known, conventional parts. By way of example, the GNN agent is configured to repurpose GAN functionality for generating clean data from poisoned data. Accordingly, the GAN can be used to tune the DNN.

In FIG. 2B, an intelligent agent is configured to crawl 201 a data pool, either autonomously, or at the request of a DNN for SaaS. The agent detects 202 adversarial examples, and then performs 203 at least one predetermined operation, such as quarantining, removing, and/or cleaning each adversarial example.

In FIG. 2C, an intelligent agent is configured to respond 210 to a request from a DNN for SaaS, retrieve 211 original data from a data pool, filter and/or clean 212 detected (e.g., 202) adversarial examples (in order to provide benign examples), and pass 213 benign examples to the DNN.

In FIG. 2D, an intelligent agent is configured for crawling 201 a data pool autonomously relative to a DNN that accesses the data pool for training, testing, or run-time operations; and removing poisoned data in the data pool by: retrieving 211 original data from the data pool; generating 222 fabricated data from the original data; and replacing 223 the original data in the data pool with the fabricated data.

In FIG. 2E, an intelligent agent retrieves 211 original data from the data pool; adds 232 noise to multiple evaluations of the original data; based on the multiple evaluations, computes 233 the proximity of the original data to a decision boundary; and responds 234 to the proximity determination. For example, the proximity might be used to determine (e.g., 202) the likelihood of adversarial data. The response 234 might include quarantining, removing, and/or cleaning (e.g., 203) each adversarial example.

In FIG. 2F, an intelligent agent crawls 201 a data pool; detects 242 adversarial data in the data pool; fabricates 243 benign data from the adversarial data; and replaces 244 the adversarial data in the data pool with the benign data.

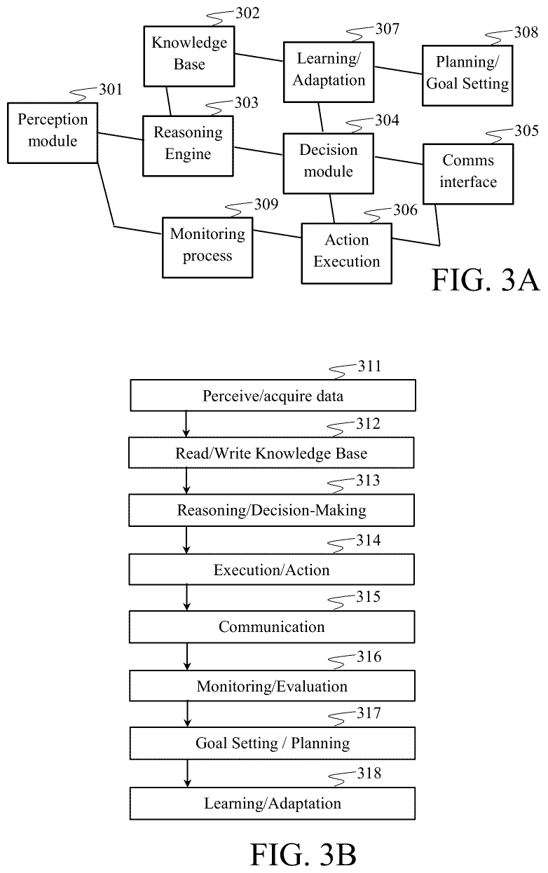

A software agent typically consists of several components that work together to enable its functionality. The specific components may vary depending on the type and purpose of the agent. FIG. 3A illustrates common components of software agent in accordance with some disclosed aspects.

Perception 301: This component allows the agent to gather information from its environment. It may involve sensors, input devices, or data collection mechanisms that enable the agent to sense and perceive relevant data.

Knowledge Base 302: The knowledge base is a repository of information or data that the agent uses to make decisions or perform actions. It can store rules, facts, heuristics, or other forms of knowledge representation.

Reasoning Engine 303: The reasoning engine is responsible for processing and analyzing the information gathered from the perception component to draw conclusions, which can be used (along with the knowledge base) by decision-making to make decisions or determine appropriate actions. The reasoning engine is configured for applying logical reasoning, inference, or other computational techniques to draw conclusions or solve problems. It may involve various algorithms, heuristics, or logical reasoning mechanisms.

Decision-making 304: This component incorporates algorithms or mechanisms for the agent to make choices based on its perception, knowledge, and reasoning. It involves evaluating different options, selecting the most suitable one, and initiating appropriate actions.

Communication 305: Agents often need to interact with other entities or systems. The communication component enables the agent to send and receive messages or data to collaborate, negotiate, exchange information, or coordinate actions with other agents, systems, and/or users.

Action Execution 306: Once a decision is made, the agent needs to carry out actions in the environment. The action execution component allows the agent to interact with the system or environment, performing physical or virtual actions based on its decisions.

Learning and Adaptation 307: Some agents have the ability to learn from their experiences and adapt their behavior over time. This component includes mechanisms such as machine learning algorithms, reinforcement learning, or other techniques to improve performance or respond to changing conditions.

Planning/Goal Setting 308: Agents often operate with specific goals or tasks in mind. This component manages the agent's goals, plans, and task execution. It may involve goal setting, planning algorithms, task scheduling, or coordination mechanisms.

Monitoring and Evaluation 309: Agents may need to monitor their own performance or receive feedback from the environment or users. This component enables the agent to assess its actions, gather performance metrics, and incorporate feedback to refine its behavior.

These components can work together to create an intelligent and autonomous software agent capable of perceiving its environment, reasoning about it, making decisions, taking actions, and learning from its experiences. It's important to note that the exact composition and architecture of software agents can vary significantly depending on the specific application domain, goals, and design choices.

A method of operating a software agent is depicted in FIG. 3B. Functional elements disclosed herein might be performed in an alternative order.

Perception 311: the agent perceives or gathers information from their environment to make informed decisions. This can involve interfacing with sensors and/or other data collection mechanisms, or receiving input from other systems.

Knowledge Base (Store/Retrieve) 312: The agent is configured for storing and retrieving information about the environment, preferences, domain-specific knowledge, rules, and/or models. This knowledge base serves as a basis for decision-making, problem-solving, and/or taking actions.

Reasoning/Decision-Making 313: The agent might employ any of various reasoning mechanisms to process available information and make decisions. This can involve logical inference, probabilistic reasoning, machine learning algorithms, and/or rule-based techniques.

Execution/Action 314: Once a decision or plan is formed, the agent might execute actions in the environment. This can involve interacting with software or hardware components, sending commands, or initiating processes. This can involve interfacing with the external environment, triggering appropriate actions, or sending commands to other systems.

Communication 315: The agent is configured to communicate with other agents or external entities to exchange information, coordinate activities, collaborate, and/or negotiate. This can involve message passing, communication protocols, APIs, and/or other communication mechanisms.

Monitoring/Evaluation 316: This can involve the agent observing its own and/or another agent's actions, measuring the effectiveness or efficiency of the actions, and providing feedback for learning or performance evaluation purposes. The agent might assess its own behavior and make adjustments as necessary, and/or it might assess the behavior of other agents.

Goal Setting 317: The agent can be configured for setting goals and planning actions to achieve those goals. The goal-setting component defines and manages these goals, such as providing for a purpose and direction. Planning involves generating a sequence of actions or steps that lead to a desired outcome.

Learning/Adaptation 318: Agents can improve their performance over time by learning from experience or by adapting to changes in their environment. This can involve updating their knowledge base, adjusting models or parameters, or acquiring new knowledge through interaction or training.

Byzantine fault tolerance (BFT) is a concept in distributed computing that refers to the ability of a system to withstand and continue functioning correctly in the presence of faulty or malicious components, known as Byzantine faults. These faults can include components that exhibit arbitrary and unpredictable behavior, such as sending conflicting or misleading information, omitting messages, or behaving in an inconsistent manner.

To achieve Byzantine fault tolerance, consensus protocols are used to ensure that the correct nodes in a distributed system can agree on a consistent value or decision, even when a certain number of faulty or malicious nodes exist. The consensus protocol allows nodes to exchange messages and reach an agreement despite the presence of Byzantine faults.

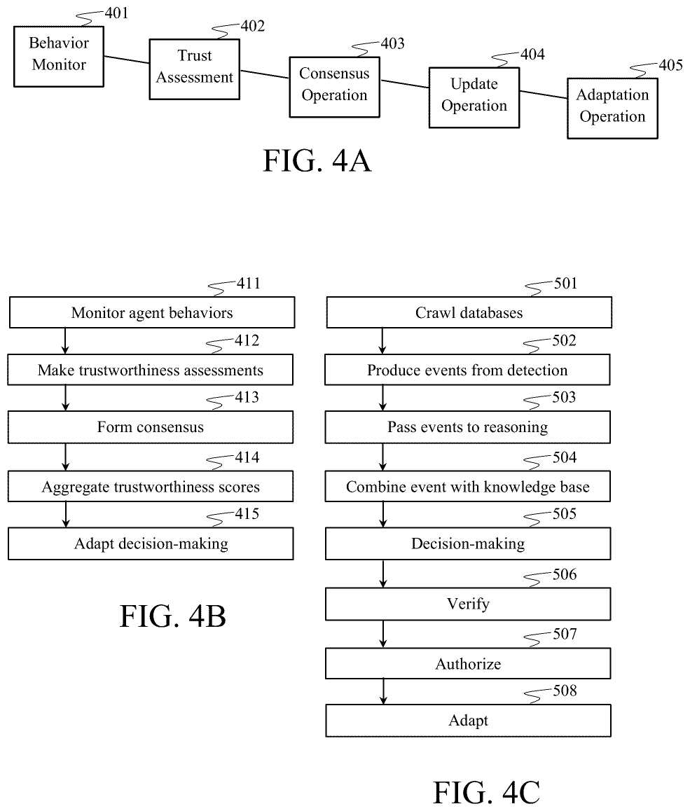

In a distributed system where autonomous agents collaborate and work together to achieve a common objective, it is essential to establish trust among the agents to ensure the system's reliability and Byzantine fault tolerance. One approach to achieving this is by monitoring and evaluating the behavior of each agent to determine their trustworthiness and using consensus to establish a global trustworthiness score for each agent. Such a process is illustrated in FIG. 4B

Monitoring Behavior 411: Agents continuously monitor the behavior of other agents in the system. This monitoring can involve observing the actions, communication patterns, and performance of other agents. Agents may collect information such as the number of successful tasks completed, adherence to protocols, response times, or consistency in behavior.

Local Trustworthiness Assessment 412: Based on the monitored behavior, each agent independently evaluates the trustworthiness of other agents. They may use various metrics, algorithms, or models to assess trustworthiness. For example, an agent could assign a trust score based on the observed behavior, previous interactions, or reputation systems.

Consensus Formation 413: Agents engage in a consensus process to exchange their local trustworthiness assessments and collectively determine a global trustworthiness score for each agent. Consensus algorithms, such as voting-based protocols or distributed agreement mechanisms, can be employed. Agents share their assessments, compare them with others, and iteratively converge towards a common trustworthiness score for each agent.

Trustworthiness Score Aggregation 414: Once consensus is reached, the trustworthiness scores from different agents are aggregated to obtain a global trustworthiness score for each agent. This aggregation could involve averaging the scores, considering the weights assigned to different agents, or applying statistical methods to derive a comprehensive measure of trustworthiness.

Trust-based Decision Making 415: The global trustworthiness scores serve as a basis for making decisions and determining the level of trust placed in each agent. Agents can use this information to select partners for collaboration, assign tasks or responsibilities, or adjust their own behavior based on the trustworthiness of other agents. Higher scores indicate a higher level of confidence in an agent's ability to perform reliably.

By monitoring each other's behavior, evaluating trustworthiness, and establishing a global trustworthiness score through consensus, the system improves its Byzantine fault tolerance. Agents can make informed decisions about cooperating with trustworthy agents while minimizing the impact of potentially malicious or faulty agents. This approach helps ensure the integrity and reliability of the system even in the presence of Byzantine faults.

FIG. 4A illustrates components of a software agent according to some aspects:

Behavior Monitor 401: Each agent in the system might employ its perception module 301, monitoring process 309, and/or possibly its communication interface 305 to continuously monitor and observe the behavior of their peers. This monitoring can include tracking message exchanges, verifying the correctness of computations or actions, and assessing the overall consistency and reliability of each agent.

Trust Assessment 402: Based on the observed behavior, each agent assigns a trustworthiness score to its peers. This score reflects the agent's subjective evaluation of how reliable, honest, and consistent a peer's behavior has been over time. The trust assessment can be performed using various algorithms or heuristics, considering factors like past performance, reputation, historical data, or even feedback from other agents. Trust assessment 402 might be performed using the reasoning engine 303, decision module 304, and knowledge base 302. Trust assessment 402 might further comprise monitoring 309, learning/adaptation 307, and/or planning/goal setting 308.

Consensus Operation 403: To establish a global trustworthiness score for each agent, a consensus mechanism is employed. Agents exchange their individual trustworthiness scores (e.g., via each agent's communications interface 305) and collaborate (e.g., via each agent's reasoning engine 303 and decision module 304) to reach a consensus on the trustworthiness of each agent in the system. Consensus algorithms, such as voting-based systems or distributed agreement protocols, can be utilized to aggregate the trustworthiness scores and determine a consistent global view.

Trustworthiness Update Operation 404: The consensus-based global trustworthiness scores might be periodically updated based on the ongoing monitoring of behavior and the consensus process. As agents continue to interact and gather more data, their trust scores can be adjusted to reflect the latest observations and consensus results.

Adaptation Utilizing Trustworthiness Information 405: The calculated trustworthiness scores can then be used to inform decision-making processes (e.g., 304) within the system. For example, the agent may prioritize interacting with more trustworthy peers, adjust the weight given to a peer's input based on their trustworthiness, or even take proactive measures to mitigate the influence of untrustworthy agents. In the case of collaborative learning (e.g., 307), collaborative planning/goal setting (e.g., 308), and/or updating the knowledge base (e.g., 302), inputs from other agents can be weighted based on their trustworthiness (i.e., confidence) scores in order to minimize the influence of malicious agents on the agent's operations.

In one aspect of the disclosure, data-mining agents use information technology to find trends and patterns in an abundance of information. Classification is a type of data mining that finds patterns in information and categorizes them into different classes. Data mining agents can also detect major shifts in trends or a key indicator and can detect the presence of new information. In one example, a method depicted in FIG. 4C comprises the steps of:
1. An agent uses its access methods to crawl 501 local and/or remote databases to retrieve data.
2. The agent may use its detailed searching or language-processing machinery to detect signatures (e.g., attack signatures) and produce events 502 therefrom.
3. Events are then passed 503 to the agent's reasoning or inferencing machinery in order to decide what to do in response to the event.
4. This process combines 504 the event content with the rule-based or knowledge content, which might be provided by the DNN, other agents, and/or external systems.
5. The agent may decide 505 to take an action based on the event; for example, inform the DNN of malicious content, cleaning the malicious content, quarantining the malicious content, or destroying the malicious content.
6. This decision and/or action is verified 506 by a security function that is internal or external to the agent, and might employ a consensus mechanism. The security function might employ consensus.
7. Upon verification, an authorizing entity gives the agent authorization 507 to execute the action. The authorizing entity might employ consensus.
8. If the authorizing entity confirms that the event is important, it may instruct the agent (and possibly other agents) to employ its learning machinery to increase 508 its weighting for this kind of event.

In some aspects, given a task, a foundation model, as a central system, might outline the action and potentially connect to APIs or other models to achieve sub-tasks for the action. In some aspects, an agent might self-prompt to complete a task. AI agents can interact and autonomously plan tasks. Agents might be equipped with external memory streams that store observations and include a retrieval mechanism to recall relevant memories. The framework might use prompting to instruct agents to extract high-level “reflections” and recursively create and update plans.

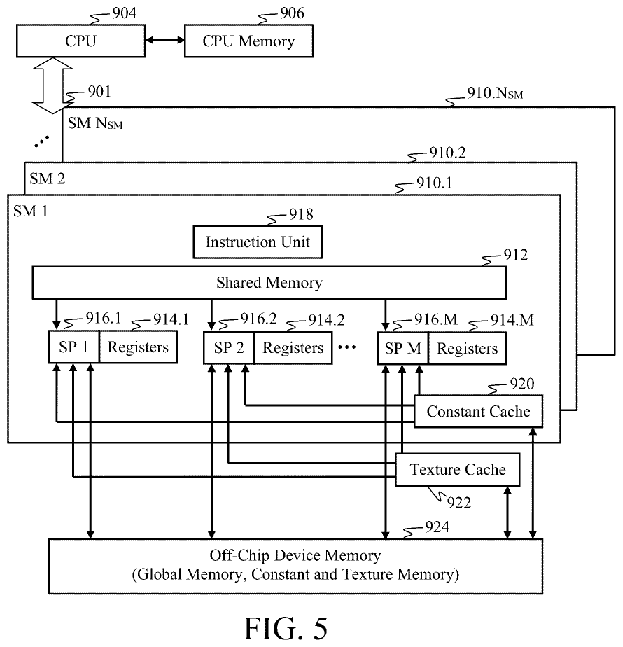

Disclosed aspects might be employed using any of various computing architectures. By way of illustration, FIG. 5 depicts a GPU parallel computing architecture that includes N_{SM} levels of streaming multiprocessors (SMs) 910.1-910.N (SM 1, SM 2, . . . , SM N_{SM}), each comprising a shared memory component 912, a level of M registers 914.1-914.M, a level of streaming processors (SPs) 916.1-916.M (SP 1, SP 2, . . . , SP M), an instruction unit 918, a constant cache component 920, and a texture cache component 922. There are various memories available in GPUs, which can be organized in a hybrid cache and local-store hierarchy. The memories can include off-chip global memory, off-chip local memory, on-chip shared memory, off-chip constant memory with on-chip cache, off-chip texture memory with on-chip cache, and on-chip registers. An off-chip device memory component 924 can include global memory and/or constant and texture memory. The GPU architecture can include or be communicatively coupled 901 to a CPU 904 and a CPU memory 906, which may be adapted to store computer-readable instructions and data for performing the activity of the CPU 904. The CPU 904 may be in operative communication with components of the GPU architecture or similar components via a bus, a network, or some other communication coupling. The CPU 904 may effect initiation and scheduling of the processes or functions performed by the GPU architecture.

The shared memory 912 is present in each SM and can be organized into banks. Bank conflict can occur when multiple addresses belonging to the same bank are accessed at the same time. Each SM 910.1-910.N also has a set of registers 914.1-914.M. The constant and texture memories are read-only regions in the global memory space and they have on-chip read-only caches. Accessing constant cache 920 is faster, but it has only a single port and hence it is beneficial when multiple processor cores load the same value from the cache. Texture cache 924 has higher latency than constant cache 920, but it does not suffer greatly when memory read accesses are irregular, and it is also beneficial for accessing data with two-dimensional (2D) spatial locality.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

The various illustrative blocks and components described in connection with the disclosure herein may be implemented or performed with a specially-programmed device, such as but not limited to a processor, a digital signal processor (DSP), an ASIC, an FPGA, a CPU, a GPU, or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

1. A computer processor circuit implementing at least one of a generative adversarial neural network (GNN) agent and a Stochastic Neural Network (SNN) agent, configured for:
crawling a data pool autonomously relative to a deep learning neural network (DNN) that accesses the data pool for training, testing, or run-time operations; and
removing poisoned data in the data pool by:
retrieving original data from the data pool;
generating fabricated data from the original data; and
replacing the original data in the data pool with the fabricated data.

2. The computer processor of claim 1, wherein generating fabricated data from the original data comprises employing a generator neural network and a discriminator neural network, wherein the generator neural network is tuned by adapting weights in the generator neural network that maximize the discriminator's loss function.

3. The computer processor of claim 1, wherein the DNN comprises a large language model and the GNN employs a Grammatical Neural Network configured to read the original data and generate the fabricated data therefrom.

4. The computer processor of claim 3, wherein the Grammatical Neural Network is configured to perform at least one of spell checking, grammar checking, punctuation checking, detection of anomalous characters, and detection of particular patterns of characters.

5. The computer processor of claim 3, wherein the Grammatical Neural Network is configured to generate the fabricated data by at least one of changing sentence structure, changing word sequencing, changing phraseology, changing style, or replacing words with their synonyms.

6. The computer processor of claim 1, wherein the fabricated data is configured to more efficiently tune the DNN.

7. The computer processor of claim 1, further configured to monitor at least one other agent's behavior, generate at least one trustworthiness score for the at least one other agent based on the at least one other agent's behavior, and communicate the at least one trustworthiness score to other agents.

8. A computer processor circuit implementing at least one of a generative adversarial neural network (GNN) agent and a Stochastic Neural Network (SNN) agent, configured for:
crawling a data pool autonomously relative to a deep learning neural network (DNN) that accesses the data pool for training, testing, or run-time operations; and
mitigating poisoned data in the data pool by:
retrieving original data from the data pool;
adding noise to multiple evaluations of the original data;
from the multiple evaluations, determining a proximity of the original data to a decision boundary; and
upon the proximity being less than a threshold value, causing the original data in the data pool to be removed, quarantined, or replaced.

9. The computer processor of claim 8, wherein causing the original data in the data pool to be removed, quarantined, or replaced is configured to more efficiently tune the DNN.

10. The computer processor of claim 8, wherein the DNN comprises a large language model and the SNN employs a Grammatical Neural Network configured to read the original data; and wherein adding noise comprises the Grammatical Neural Network operating on the original data to perform at least one of changing sentence structure, changing word sequencing, changing phraseology, changing style, or replacing words with their synonyms.

11. The computer processor of claim 10, wherein causing the original data in the data pool to be replaced is implemented by the Grammatical Neural Network, wherein replacement data is made from the original data by at least one of changing sentence structure, changing word sequencing, changing phraseology, changing style, or replacing words with their synonyms.

12. The computer processor of claim 8, further configured to monitor at least one other agent's behavior, generate at least one trustworthiness score for the at least one other agent based on the at least one other agent's behavior, and communicate the at least one trustworthiness score to other agents.

13. A computer processor circuit implementing an agent comprising at least one generative adversarial neural network (GNN) and at least one Stochastic Neural Network (SNN), the computer processor configured for:
retrieving original data from a data pool;
employing the SNN for adding noise to multiple evaluations of the original data;
from the multiple evaluations, determining a proximity of the original data to a decision boundary;
based on the proximity, determining if the original data is adversarial;
upon determining that the original data is adversarial, employing the GNN to fabricate benign data from the original data; and
replacing the original data in the data pool with the benign data.

14. The computer processor of claim 13, wherein the GNN comprises a generator and a discriminator; wherein the discriminator employs the SNN for adding noise to multiple evaluations of data received from the generator; and wherein the discriminator employs the multiple evaluations of data received from the generator for classifying the data received from the generator.

15. The computer processor of claim 13, wherein replacing the original data in the data pool is configured to more efficiently tune a DNN that access the data pool.

16. The computer processor of claim 13, wherein the SNN employs a Grammatical Neural Network configured to read the original data; and wherein adding noise comprises the Grammatical Neural Network operating on the original data to perform at least one of changing sentence structure, changing word sequencing, changing phraseology, changing style, or replacing words with their synonyms.

17. The computer processor of claim 16, wherein replacing the original data in the data pool is implemented by the Grammatical Neural Network, wherein replacement data is made from the original data by at least one of changing sentence structure, changing word sequencing, changing phraseology, changing style, or replacing words with their synonyms.

18. The computer processor of claim 13, further configured to monitor at least one other agent's behavior, generate at least one trustworthiness score for the at least one other agent based on the at least one other agent's behavior, and communicate the at least one trustworthiness score to other agents.

19. The computer processor of claim 13, wherein its permission for replacing the original data is based on a trustworthiness score determined by other agents.
